(19) United States
(12) Patent Application Publication
(10) Pub. No.: US 2013/0165543 A1
(43) Pub. Date: Jun. 27, 2013

(54) CONCRETE SUBSTITUTE

(71) Applicant: Andrew James Allen, Wisbech Cambridgeshire (GB)

(72) Inventor: Andrew James Allen, Wisbech Cambridgeshire (GB)

(21) Appl. No.: 13/811,316

(22) PCT Filed: Jul. 21, 2010
(86) PCT No.: PCT/GB10/51202

§ 371 Date: Jan. 21, 2013

(51) Int. Cl. C08L 75/00

(52) U.S. Cl. CPC C08L 75/00
USPC 521/157; 524/875; 521/170; 525/123; 524/788; 524/700; 264/299

(57) ABSTRACT

A concrete substitute material (30) which is environmentally friendly in its manufacture and use. The material (30) comprises a mix of petrochemical based polyols (11), renewable polyols (12), isocyanate (20) and filler material (21). Products (34) formed by curing of the material (30) can be recycled, and are lightweight, strong and durable.

This invention relates to a concrete substitute material with a major component of renewable components. The invention also relates to a method of forming a product from a concrete substitute material and products formed from such a process.

Concrete is the worlds most widely used man-made material and is used for a vast range of construction purposes. There are many different types of concrete, but all comprise the same main components: cement, aggregate and water. When these components are combined in the appropriate quantities the water reacts with the cement and binds to the aggregate to form a hard solid material. The production of cement is an energy intensive process and requires raw materials to be heated in a cement kiln at extremely high temperatures. The cement forming process consumes a large amount of energy, particularly in the heating stage and is one of the most energy intensive of all industrial manufacturing processes. The combustion of fossil fuels to operate the kiln and the chemical reactions between the components generates a variety of hazardous emissions, including carbon dioxide, mercury, nitrogen oxides, sulphur dioxide, carbon monoxide, dioxins and furans, polychlorinated biphenyls, polycyclic aromatic hydrocarbons, benzene, toluene, ethylbenzene, xylene, gaseous inorganic chlorine compounds, chlorides and gaseous fluorine compounds. These emissions can be extremely harmful. For example, exposure to mercury, which is a potent neurotoxin, can damage developing nervous systems, affect fertility and blood pressure regulation and can cause memory and vision loss, tremors and numbness in the fingers and toes.

The production of cement and concrete generates high levels of pollutant emissions, which are not only hazardous to health but which also have a detrimental effect on the environment. It is estimated that cement and concrete production accounts for between 5-10% of all carbon dioxide emissions. With increasing concerns of climate change due to greenhouse gases, there is a need to reduce the amount of air pollution generated by industrial manufacturing processes.

Concrete can be recycled but not economically and as a result waste concrete is often supplied to landfill sites.

Due to the structure of the components, products formed from concrete, such as kerbstones, are heavy and require mechanical lifting equipment to lift and manoeuvre during installation. This not only makes them difficult to handle but also expensive to transport.

Attempts to tackle the above issues have been made by forming “concrete type” materials using recycled thermoplastic components. These materials are not capable of withstanding the variations in temperature of the environment and cannot be used effectively in warm climates. Thus these existing products lack particular desirable characteristics of concrete.

It is a principal aim of the present invention to address the environmental damage caused by concrete production, installation and disposal and to provide a concrete substitute material which has all of the benefits of concrete but which is also environmentally friendly in its manufacture and use, which can be recycled and which can be used to produce products which are lightweight, strong and durable. The invention aims to fight climate change by reducing energy consumption and the production of harmful emissions in the manufacture of such products.

According to this invention, there is provided a curable concrete substitute material comprising, prior to curing, the following components:
a). a polyol mix comprising:
   i. a petrochemical based polyol; and
   ii. a natural renewable based polyol;
b) an isocyanate; and
c) a particulate filler.

The term “natural” as used herein with reference to the polyol is intended to mean a polyol derived from a renewable, sustainable, raw source such as from plants or animals. This is in contrast to petrochemical based polyols which are derived from petroleum and other fossil fuels, such as oil or natural gas. Ideally, the natural renewable polyol is derived from organic matter selected from vegetable oil or marine-based oil. Preferably, the natural renewable polyol is derived from rapeseed oil. By providing a natural renewable based polyol, the use of fossil fuels is reduced and thus the amount of harmful emissions formed in the manufacture of a concrete substitute material is significantly less.

In order to produce concrete substitute products of minimal weight and cost, it may be desirable to include a blowing agent component into the concrete substitute material. The term blowing agent as used herein is intended to mean any agent which causes expansion of the material including those commonly referred to as foaming agents. The blowing agent is an additive which produces an expanded cellular structure after curing. Thus, by providing a blowing agent, the volume of cured product produced is increased. The products formed from the material of the present invention may be considerably less dense than if produced from concrete and if a blowing agent is used the density will be further reduced.

One important environmental property of a blowing agent is the Global Warming Potential value, (commonly referred to as the GWP value). The GWP value, as the name suggests, is a measure of the potential for a blowing agent to increase greenhouse gas emissions. With rising concerns as to the detrimental effects of global warming, it is desirable to maintain greenhouse gas emissions at a minimum. It is therefore advantageous if the blowing agent has a low GWP value. Preferably, the blowing agent has a GWP value of less than ten, and even more preferably, a GWP value of less than or equal to one. The blowing agent may be water or methyl formate, as this has the desirable properties.

The particulate filler may comprise particles of one material or a mixture of different materials. Preferably, the particulate filler comprises recovered waste selected from one or more of the following materials: rubber; industrial, agricultural or household waste; fly-ash; dry sand; chalk. The waste may be processed (for example by shredding or milling) and formed into particulate material such as pellets, particles or granules of a suitable size prior to combining with other components. The waste may be progressively processed through multiple shredding or milling machines. Advantageously, the use of waste materials, such as rubber from waste tyres may benefit the environment as it serves to lower the number of tyres and/or other waste that are stockpiled or illegally discarded. The particle size of the filler may be between 1 and 10 mm, and preferably is between 1 and 4 mm.

The isocyanate component is preferably a polymeric isocyanate, as polymeric isocyanates are lower in toxicity than raw isocyanate. It is preferred that the isocyanate is polymeric methylenediphenyldiisocyanate as this is one of the least hazardous types of isocyanate. The purpose of the isocyanate component is to react with polyol mixture to effect curing.

The concrete substitute material may further comprise one or more of the following additives: catalysts, pigments, plasticisers, fire-retardants and surfactants. These additives may be incorporated to control and modify the reaction process of the curing and the performance characteristics of the cured material.

Ideally, the natural renewable polyol may comprise 30-50% by volume of the polyol mix. By having a substantial percentage of the polyol mix as a renewable polyol, it has been found that the level of carbon dioxide and other emissions is greatly reduced and that performance of the cured material is not adversely effected.

To minimise the cost of producing products formed with the concrete substitute material, the volume of filler may be high relative to the overall volume of binder material (i.e. the other components). Preferably, the particulate filler comprises 70-95% by volume of the concrete substitute material.

The polyol and isocyanate components are provided as liquids, which when combined react to form a hard solid, known as polyurethane. The quantity of polyol and isocyanate required depends on the desired characteristics of the product to be formed. In a preferred embodiment, the ratio by volume of polyol mix to isocyanate is 1:1.

Optional components if included in the composition are usually combined with the polyol mix prior to the addition of the isocyanate. The term polyol mix includes such optional components if present. These may include catalysts in an amount of 1-3% by volume of the polyol mix; pigments in an amount of 1-3% by volume of the polyol mix; and blowing agents in an amount of 5-16% by volume of the poly mix.

The optimum quantities of each component are dependant greatly on the end use of items formed with the concrete substitute material.

In a particular preferred formulation, the composition prior to addition of isocyanate or particulate matter may comprise a set of components, within the following ranges:
25-75% by volume of petrochemical based polyols;
15-55% by volume of natural renewable polyols;
1-3% by volume of catalysts;
1-3% by volume of pigments; and
5-16% by volume of blowing agents.

In a different preferred embodiment, for forming a more solid construction product, such as kerbstones, the mix prior to addition of isocyanate or particulate matter may comprise:
50% by volume of petrochemical based polyols;
35% by volume of natural renewable polyols;
2% by volume of catalysts;
2% by volume of pigments; and
11% by volume of blowing agents.

Of course, the quantities of each component can vary significantly from those figures defined herein, and this would not depart from the scope of the invention.

The mechanical properties such as strength of products formed with the concrete substitute material are likely to be greater than concrete due to the polymeric cellular structure. The main advantage of the higher strength is that a product may be formed using less material, as wall thickness can be reduced without losing the required strength and in many cases reinforcement may not be necessary.

According to a second embodiment of this invention there is provided a method of forming a concrete substitute product comprising the following steps:
A) forming a polyol mix comprising:
   i. a petrochemical based polyol; and
   ii. a natural renewable polyol;
B) combining the polyol mix with an isocyanate and a particulate filler;
C) charging the mixture of polyol mix, isocyanate and particulate filler into a mould; and
D) allowing the mixture to cure.

In step A), the polyol mix is composed of both natural renewable polyols and conventional polyols. In this way, the product makes use of renewable raw materials and does not rely on the limited supply of petrochemical-based products.

The polyol mix and isocyanate combine to form polyurethane. The polyol mix formed in step A) may further comprise various optional components as discussed above. These may include a blowing agent to obtain a foamed, or expanded polyurethane after curing when combined with the isocyanate. Alternatively, the blowing agent may be introduced at any suitable point up to and including the charging of the mould.

In step B), the polyol mix, isocyanate and particulate filler may preferably be supplied to a specialised dispensing machine which mixes the components together under high pressure and charges them into the mould. The mixture is charged into moulds conforming to the desired shape. If a blowing agent has been introduced into the material, then the mould need only be partially filled. This is because the blowing agent will cause the material to expand automatically and within the mould to fill it. When combined in appropriate amounts, the components of the polyol mix and isocyanate automatically react with each other and a chemical curing process occurs. Following the filling of a mould a lid may be placed on the top to retain heat within the mould and allow the material to expand. Any suitable mixing, charging and moulding process can be used.

The concrete substitute material may be compacted by vibration to prevent air gaps forming within the material. The material is then left in the mould to cure sufficiently. The time taken for the product to harden and cool down depends on the nature and amount of components used and can vary between a few seconds to a few hours. Once cured and sufficiently cooled, the product can be removed from the mould. Due to the strong binding action of the components, the hard solid product formed from the concrete substitute material may be removed in its entirety from the mould without leaving any residue. As a result, the moulds do not require cleaning and can be used over and over again without maintenance.

Other optional constituents may be included to control and modify the reaction process of the curing and/or the performance characteristics of the cured material. Further optional constituents may include one or more of the following: catalysts, pigments, plasticisers, fire-retardants and surfactants. These additives may be introduced at any suitable point up to and including charging of the mould, but preferably are combined into the polyol mix in step A) or combined with the mix in step B).

The concrete substitute material can be used in substantially all applications where concrete is used, including construction and landscaping, in addition to many other uses. Products formed from the concrete substitute material or by the method described herein include, but are not limited to, kerbstones, paving, central barriers, jersey barriers; bollards, temporary run-ways and bunding for oil leaks.

Products formed from the concrete substitute material are not susceptible to frost damage, are lightweight and may be buoyant. They are substantially formed from recycled materials and are recyclable. The production of hazardous emissions in the manufacture of products from the concrete substitute material may be significantly less than those generated during production of concrete.

By way of example only, one specific method for forming a concrete substitute material and a product formed from such a substitute material will now be described in detail, reference being made to the accompanying drawings in which:

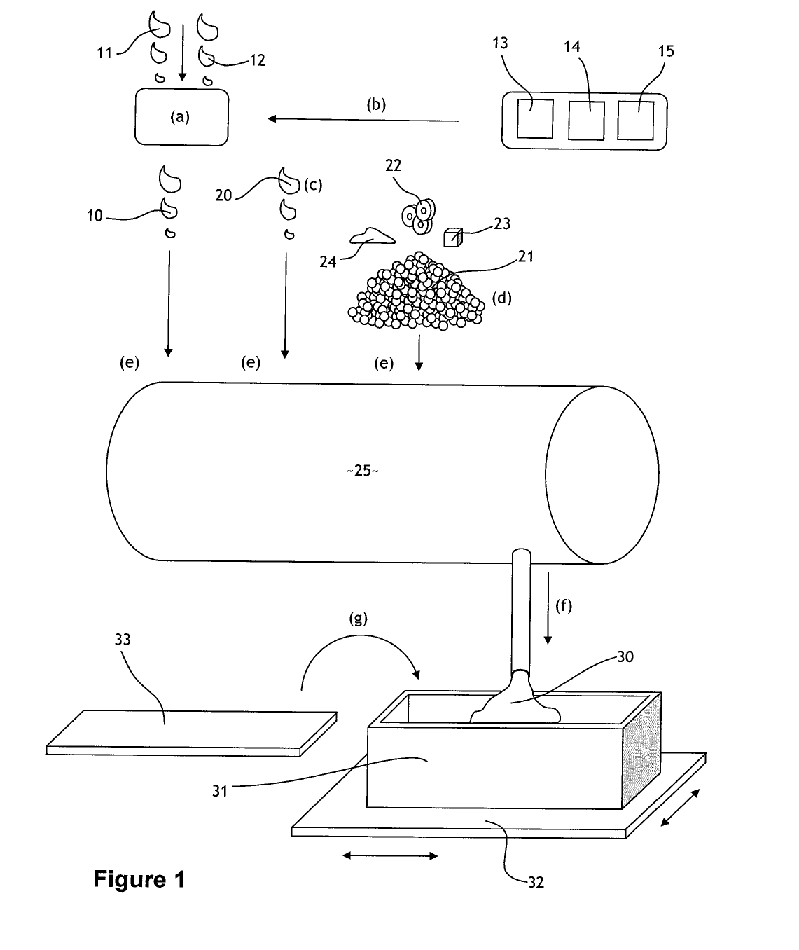

FIG. 1 is a figurative representation of a method of forming a concrete substitute product according to the present invention; and

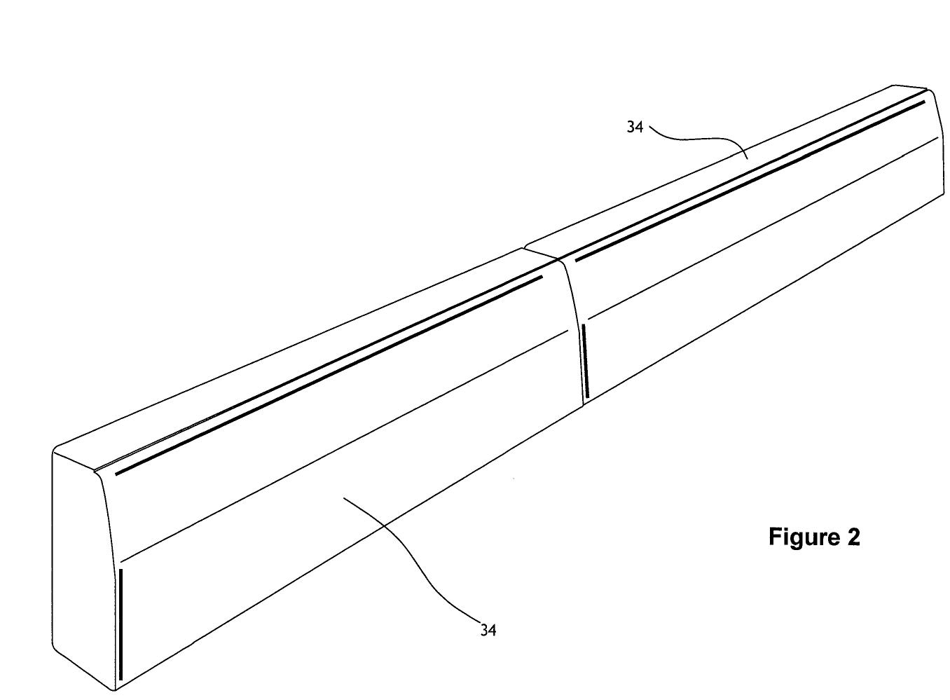

FIG. 2 is a perspective view of a product comprising a composition formed using the method outlined in FIG. 1.

A method according to the present invention is described with reference to the formation of a moulded paving kerb from a concrete substitute material.

In step (a) a mix 10 is formed by combining a petrochemical based polyol 11 with a renewable polyol 12, derived from rapeseed oil. In step (b), further additives in the form of blowing agents 13, catalysts 14 and pigments 15 are added to the mix 10. In this embodiment, the mix 10 consists, by volume, of 50% petrochemical derived polyol 11, 35% renewable organically derived polyol 12, 11% blowing agent, 2% catalyst and 2% pigment.

An isocyanate, namely polymeric methylenediphenyldiisocyanate 20 is prepared at step (c), and separately a particulate filler 21 is prepared at step (d). The particulate filler 21 is prepared by milling reclaimed waste such as tyres 22, industrial waste 23 and/or waste products such as fly ash from power stations 24. In this embodiment, the amount by volume of particulate filler is 80% of the overall finished concrete substitute material. The greater the quantity of particulate filler, the less the amount of the other components that is required. Thus the cost of a final product can be reduced. The isocyanate is provided in an amount equal to the amount of polyol supplied in the overall mix.

The mix 10, isocyanate 20 and filler 21 are added in suitable amounts to a mixing machine 25, as shown in step (e). While in this embodiment, the blowing agents 13, catalysts 14 and pigments 15 are added to the polyol mix 10 in step (b), these additives can alternatively be combined into the machine 25 in step (e). The mixing machine 25 is adapted to mix the materials under suitable pressure and to initiate curing by reaction of the isocyanate with the polyols to form a curable mix 30.

Moulds 31 which define the desired shape of the intended product, in this case paving kerbs, are provided. These moulds 31 are positioned on a vibration plate 32 and the curable mix 30 is introduced into the moulds from the machine 25.

As illustrated in step (f), the curable mix 30 is poured into the mould 31 to partially fill the mould. Room is left to allow space for expansion caused by the blowing agent. The vibration plate 32 serves to shake the concrete substitute material 30 within the mould 31 to reduce undesirable air bubbles within the material and ensure it has suitably filled the mould.

A lid 33 is placed on the mould 31 in step (g) to maintain heat therein. A reaction between the components causes the mix 30 to expand to between 4 and 10 times its original volume, thereby entrapping any remaining particles, and filling the mould 31.

The curing reaction between the polyol mix 10 and the isocyanate 20 forms polyurethane. Polyurethane does not require temperature and/or pressure to complete the curing process and as such, the filled mould 31 is left for a suitable period of time for the filling to harden. Typical in mould curing times vary between approximately 2 minutes to 90 minutes. Once hardened and cooled the kerbs 34 formed in the mould can be removed from the mould for use.

Once the kerb 34 has been removed the process may be repeated to produce further kerbs. As shown in FIG. 2, multiple kerbs 34 can be produced and then installed side by side to delineate the edges of roads or paths.

The cellular structure of the kerbs 34 results in a strong, lightweight product. Each kerb unit can be easily handled without the need for mechanical lifting equipment and may be installed using the traditional techniques for installing concrete curbs. The kerbs are capable of resisting the normal loads and impacts likely during installation and from slow moving vehicles without damage or displacement. Due to the nature of the materials used, the kerbs 34 will withstand periods of high temperature associated with surfacing operations and contact with hot asphalt. Additionally, unlike products formed from concrete, those formed from the concrete substitute material, such as kerbs are not susceptible to damage due to freezing temperatures.

1. A curable concrete substitute material comprising, prior to curing, the following components:
a) a polyol mix comprising:
i. a petrochemical based polyol; and
ii. a natural renewable based polyol;
b) an isocyanate; and
c) a particulate filler.

2. A curable concrete substitute material as claimed in claim 1 further comprising the following additional component:
d) a blowing agent.

3. A curable concrete substitute material as claimed in claim 2, wherein the blowing agent has a Global Warming Potential value less than or equal to 1.

4. A curable concrete substitute material as claimed in claim 2, wherein the blowing agent comprises a water or methyl formate.

5. A curable concrete substitute material as claimed in claim 1, wherein the natural renewable polyol is derived from organic matter selected from vegetable oil or marine-based oil.

6. A curable concrete substitute material as claimed in claim 5, wherein the natural renewable polyol is derived from rapeseed oil.

7. A curable concrete substitute material as claimed in claim 1, wherein the particulate filler comprises waste selected from one or more of the following materials: rubber; industrial, agricultural or household waste; fly-ash; dry sand; chalk.

8. A curable concrete substitute material as claimed in claim 1, wherein the isocyanate is a polymeric isocyanate.

9. A curable concrete substitute material as claimed in claim 8, wherein the polymeric isocyanate is polymeric methylenediphenyldiisocyanate.

10. A curable concrete substitute material as claimed in claim 1 further comprising one or more further additive selected from: catalysts, pigments, plasticisers, fire-retardants and surfactants.

11. A curable concrete substitute material as claimed in claim 1, wherein the natural renewable polyol comprises 30-50% by volume of the polyol mix.

12. A curable concrete substitute material as claimed in claim 1 wherein the particulate filler comprises 70-95% by volume of the concrete substitute material.

13. A curable concrete substitute material as claimed in claim 1, wherein the ratio by volume of polyol mix to isocyanate is 1:1.

14. A curable concrete substitute material as claimed in claim 1, wherein the combination of polyol mix and optional components, prior to the addition of isocyanate and particulate filler, comprises:
50% by volume of petrochemical based polyols;
35% by volume of natural renewable polyols;
2% by volume of catalysts;
2% by volume of pigments; and
11% by volume of blowing agents.

15. A method of forming a concrete substitute product comprising the following steps:
A) forming a polyol mix comprising:
i. a petrochemical based polyol; and
ii. a natural renewable polyol;
B) combining the polyol mix with an isocyanate and a particulate filler C) charging the mixture of polyol mix, isocyanate and particulate filler into a mould; and
D) allowing the mixture to cure.

16. A method as claimed in claim 15, wherein a blowing agent is combined with the polyol mix in step A).

17. A method as claimed in claim 15, wherein a blowing agent is combined with the polyol mix, isocyanate and particulate filler in step B) or step C).

18. A method as claimed in claim 15, wherein one or more of the additives: catalysts, pigments, plasticisers, fire-retardants and surfactants are combined with the polyol mix in step A).

19. A method as claimed in claim 15, wherein one or more of the additives: catalysts, pigments, plasticisers, fire-retardants and surfactants are combined with the polyol mix, isocyanate and particulate filler in step B) or step C).

20. A concrete substitute product formed using the method as claimed in claim 15.
